(19) United States
(12) Patent Application Publication
(10) Pub. No.: US 2025/0224905 A1
(43) Pub. Date: Jul. 10, 2025

(54) STORAGE MEDIUM STORING PROGRAM, INFORMATION PROCESSING APPARATUS, AND CONTROL METHOD FOR MANAGING PRINT JOBS INCLUDING DIFFERENT DOCUMENT SIZES

(71) Applicant: CANON KABUSHIKI KAISHA, Tokyo (JP)

(72) Inventor: KAZUYUKI SAITO, Kanagawa (JP)

(21) Appl. No.: 19/007,847

(22) Filed: Jan. 2, 2025

(30) Foreign Application Priority Data
Jan. 9, 2024 (JP) 2024-001154

(51) Int. Cl. G06F 3/12

(52) U.S. Cl. CPC G06F 3/1205; G06F 3/1244; G06F 3/1255; G06F 3/1287

(57) ABSTRACT

A non-transitory computer-readable storage medium provided in an information processing apparatus, the non-transitory computer-readable storage medium storing an application program supporting a printer driver that complies with an Internet Printing Protocol (IPP), wherein the application program causes the information processing apparatus to execute determining whether image data to be printed includes different document sizes; determining, upon determining that the image data includes the different document sizes, whether at least one paper sheet for each of the different document sizes included in the image data is set in a printer that performs printing of the image data; receiving, upon determining that at least one paper sheet for each of the different document sizes included in the image data is set in the printer, selection of a first setting or a second setting from a user, the first setting being configured to perform the printing with a single sheet size selected by the user, the second setting being configured to perform the printing with each of sheets according to each of the different document sizes included in the image data; and generating, in response to receiving the selection of the second setting, IPP setting information including an IPP attribute corresponding to the second setting for instructing a target printer to perform the printing.

### BACKGROUND OF THE INVENTION

### Field of the Invention

The present invention relates to an application program, an information processing apparatus, and a method for controlling the same, and particularly relates to an application program, an information processing apparatus, and a method for controlling the same that control printing of documents including images respectively having different document sizes.

Description of the Related Art

A general-purpose printer driver (local printer driver) that directly communicates with an image forming apparatus using an industry standard protocol, specifically, Internet printing protocol (IPP) is widely used. The local printer driver is a driver provided by a vendor (manufacturer) that provides an operating system (OS) of a client terminal. The local printer driver is a printer driver that generates print data that can be interpreted by a plurality of models of printers from a plurality of printer vendors. The local printer driver can communicate with printers of the printer vendors. Therefore, by using the local printer driver, a user can transmit a print job to the image forming apparatus without installing a vendor-specific printer driver.

Furthermore, printing using a cloud print service is considered. In the cloud print service, a printer driver (cloud printer driver) for the cloud print service is installed in an information processing apparatus. The cloud printer driver is also a driver provided by an OS vendor that provides an OS of a client terminal, and is a printer driver using an industry standard protocol such as IPP that generates print data that can be interpreted by the printers of the printer vendors. In the cloud print service, the information processing apparatus transmits a print job to the cloud print service using the cloud printer driver, and the cloud print service transmits the print job to the image forming apparatus, whereby printing is executed.

Since the local printer driver and the cloud printer driver described above handle print jobs to be printed by image forming apparatuses of various vendors, there are limitations on items and functions that can be set as print settings. For example, in the local printer driver and the cloud printer driver described above, in a case where documents including images having different paper sizes are printed, there is a problem in that the document is printed with one size paper.

In order to solve such a problem, there is a technique of directly transmitting PDF files of documents to a printer so as to execute printing of the documents including images having different paper sizes while maintaining the paper sizes specified in the PDF files (refer to Japanese Laid-Open Patent Publication (kokai) No. 2017-4549).

However, in the technique of Japanese Laid-Open Patent Publication (kokai) No. 2017-4549, since the printer driver is not used, it is necessary to provide a control part that processes the PDF files on the printer side.

### SUMMARY OF THE INVENTION

The present invention provides a non-transitory computer-readable storage medium storing an application program capable of generating IPP setting information corresponding to a setting for printing with the paper size specified in document data when an instruction to print image data including different paper sizes is given via a printer driver that complies with the IPP, an information processing apparatus, and a method for controlling the same.

According to an aspect of the present invention, there is provided a non-transitory computer-readable storage medium provided in an information processing apparatus, the non-transitory computer-readable storage medium storing an application program supporting a printer driver that complies with an Internet Printing Protocol (IPP), wherein the application program causes the information processing apparatus to execute:
determining whether image data to be printed includes different document sizes;
determining, upon determining that the image data includes the different document sizes, whether at least one paper sheet for each of the different document sizes included in the image data is set in a printer that performs printing of the image data;
receiving, upon determining that at least one paper sheet for each of the different document sizes included in the image data is set in the printer, selection of a first setting or a second setting from a user, the first setting being configured to perform the printing with a single sheet size selected by the user, the second setting being configured to perform the printing with each of sheets according to each of the different document sizes included in the image data; and
generating, in response to receiving the selection of the second setting, IPP setting information including an IPP attribute corresponding to the second setting for instructing a target printer to perform the printing.

According to the present invention, when an instruction to print image data including different paper sizes is given via a printer driver that complies with the IPP, IPP setting information for printing with paper according to the paper sizes specified in document data can be generated.

Further features of the present invention will become apparent from the following description of exemplary embodiments with reference to the attached drawings.

### BRIEF DESCRIPTION OF THE DRAWINGS

FIG. 1 is a diagram showing an example of a schematic configuration of a printing system including a client terminal as an information processing apparatus according to an embodiment of the present invention.

FIGS. 2A to 2D are diagrams each showing an example of a hardware configuration of each module of the printing system.

FIG. 3 is a diagram showing a sequence of processing executed between modules of the printing system started by user selection of a print queue in the client terminal.

FIG. 4 is a flowchart showing details of determination processing on presence or absence of a paper size mixed placement function executed in step S315 of FIG. 3.

FIG. 5 is a flowchart showing details of determination processing on presence or absence of “document size priority” setting executed in step S326 of FIG. 3. In the “document size priority” setting, paper size in document data is given priority.

FIG. 6 is a flowchart showing details of PDL type determination processing supported by a printer executed in step S332 of FIG. 3.

FIG. 7A is a diagram showing a print function setting screen which is an example of a print setting UI displayed by a print setting UI part of a print setting extension application included in the client terminal.

FIG. 7B is a diagram showing an example of a paper size mixed placement pattern.

FIGS. 8A and 8B are diagrams each showing an example of a generation request of IPP setting information, which is performed by a print setting extension application in the client terminal to a print spooler by using the API of the OS in step S327 of FIG. 3.

FIG. 9 is a diagram showing a variation of the print function setting screen, which is an example of the print setting UI displayed by the print setting UI part of the print setting extension application.

### DESCRIPTION OF THE EMBODIMENTS

The present invention will now be described in detail below with reference to the accompanying drawings showing embodiments thereof.

The following embodiments do not limit the invention according to the claims. Although a plurality of features are described in the embodiments, all of the plurality of features are not necessarily essential to the invention, and the features may be arbitrarily combined. Furthermore, in the accompanying drawings, the same or similar configurations are denoted by the same reference numerals, and redundant description will be omitted.

Hereinafter, embodiments of the present invention will be described with reference to the drawings.

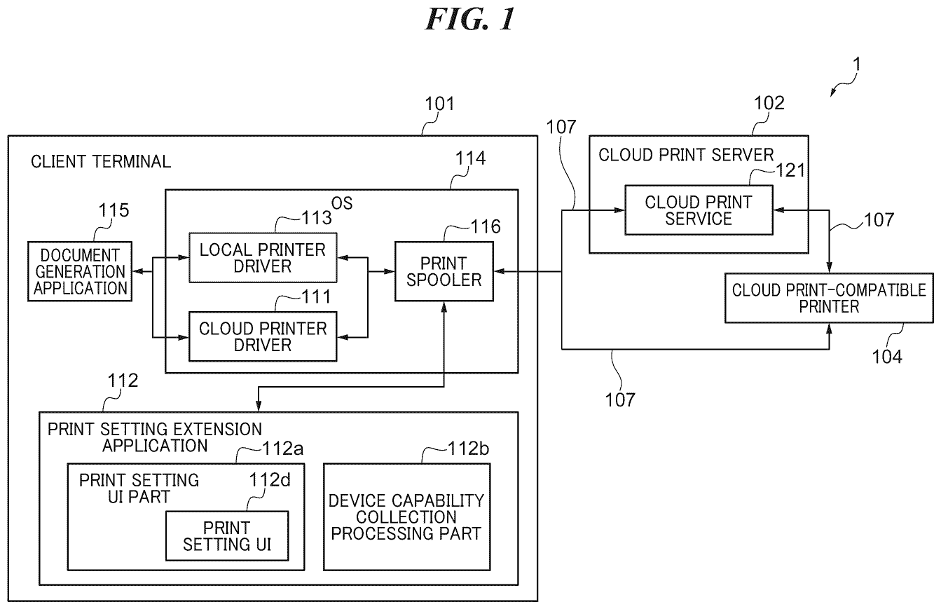

FIG. 1 is a diagram showing an example of a schematic configuration of a printing system including a client terminal as an information processing apparatus according to an embodiment of the present invention.

In FIG. 1, in a printing system 1, a client terminal 101, a cloud print server 102, and a cloud print-compatible printer 104 (hereinafter, referred to as a printer 104) are connected to each other via a network 107.

Although one client terminal 101 and one printer 104 are shown in FIG. 1, a plurality of client terminals 101 and a plurality of printers 104 may be provided.

The cloud print server 102 may be a server system including a plurality of information processing apparatuses. As a result, a load distribution can be distributed to the information processing apparatuses. Further, the cloud print server 102 may be physically configured virtually inside one information processing apparatus.

The network 107 is assumed to be a WAN such as the Internet, but may be a closed environment such as an in-house LAN.

The client terminal 101 is an information processing apparatus such as a PC, a tablet, or a smartphone, and is a terminal directly operated by a user. Any application software can be executed on the client terminal 101.

A local printer driver 113 and a cloud printer driver 111 are printer drivers provided by an operating system (OS) vendor (manufacturer) that provides an OS 114 of the client terminal 101. The local printer driver 113 and the cloud printer driver 111 are printer drivers that generate print data that can be interpreted by printers of a plurality of printer vendors and that complies with the IPP.

The local printer driver 113 is a printer driver to be used when the printer 104 and the client terminal 101 are connected to each other without passing through a server. The cloud printer driver 111 is a printer driver to be used when a cloud print service 121 in the cloud print server 102 provided by the OS vendor is used. Information on the printer 104 is registered in advance in the cloud print service 121. The client terminal 101 designates the printer 104 as an output destination of print data generated by the cloud printer driver 111, and transmits the print data to the cloud print service 121. Printing is executed by causing the cloud print service 121 to transmit print data from the client terminal 101 to the designated printer 104.

It should be noted that the local printer driver 113 and the cloud printer driver 111 are already stored in a storage part 214 of the client terminal 101 when the client terminal 101 is shipped.

A print spooler 116 is a function related to printing provided by the OS 114, and has a function of storing intermediate data and print data received from the local printer driver 113 and the cloud printer driver 111 in a temporary storage area. The print data stored in the temporary storage area is called by the print setting extension application 112 or is transmitted to the cloud print server 102 or the printer 104.

The print setting extension application 112 (application program) is one of the above-described plurality of printer vendors, and is a print setting application provided by a vendor that provides a printer used for printing. In the present embodiment, the print setting extension application 112 is stored in the storage part 214 when the client terminal 101 is shipped, but the present invention is not limited thereto. In a case where the print setting extension application 112 is not stored in the storage part 214 at the time of shipment, the print setting extension application is downloaded from an application management server (not shown) via the network 107 by a predetermined user operation on the client terminal 101. The print setting extension application 112 extends functions related to print settings of the local printer driver 113 and the cloud printer driver 111 via the print spooler 116 of the OS 114.

The printer 104 is an image forming apparatus that actually performs printing on a recording medium such as paper, and converts print data received from the client terminal 101 via the network 107 or directly into image data and prints the image data.

A print setting UI part 112a provides a user with a print setting UI 112d extended by a printer vendor in the print setting extension application 112.

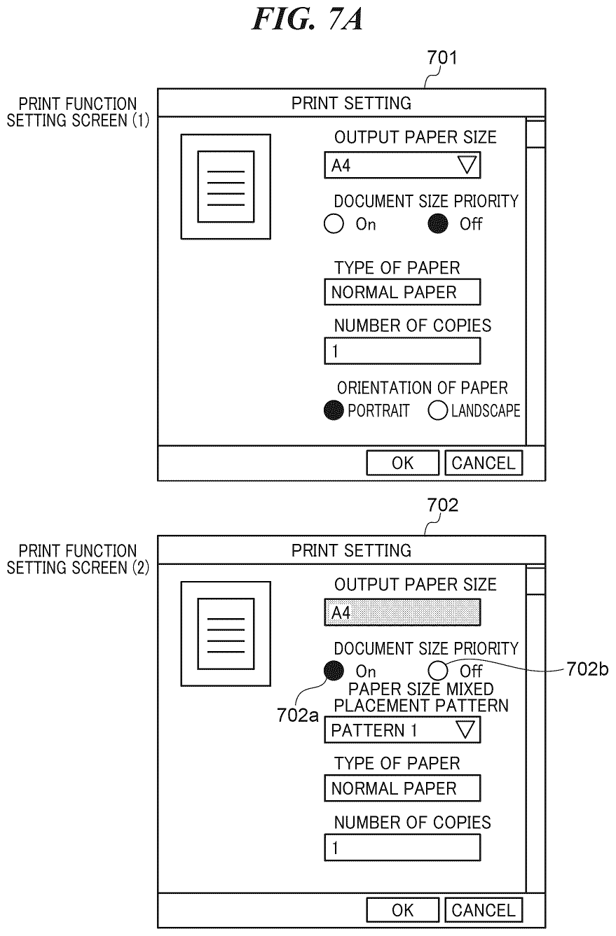

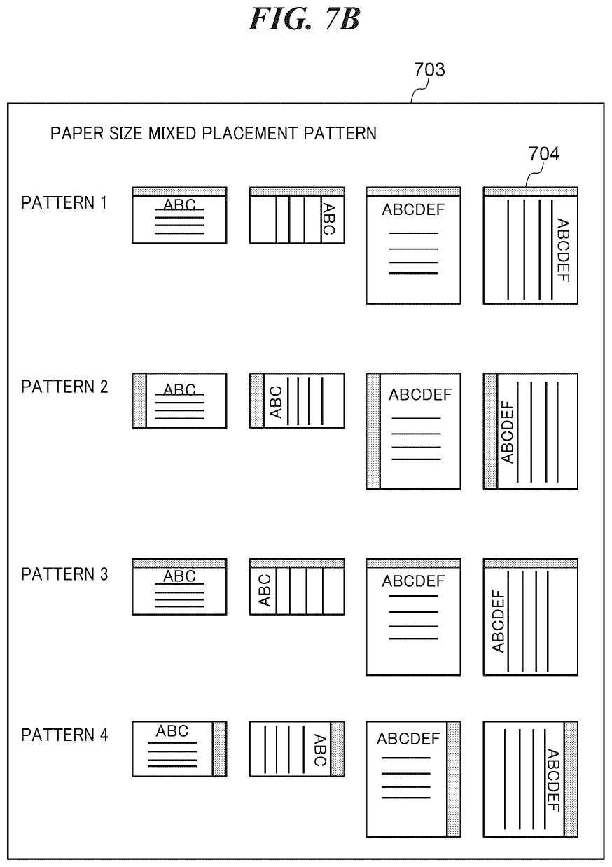

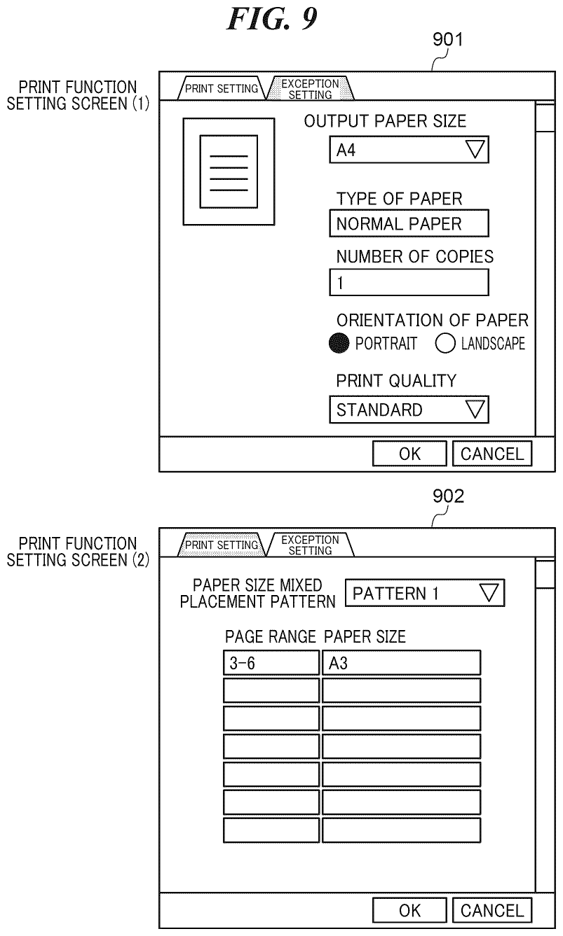

Specifically, the print setting UI part 112a generates and displays the print setting UI 112d on the basis of the capability information acquired by the OS 114 and the print setting extension application 112 from the cloud print service 121. A print function setting screen, which is an example of the print setting UI 112d, will be described later with reference to FIGS. 7A, 7B and 9.

A device capability collection processing part 112b is a module that operates the OS 114 to collect the capability information of the printer 104 and to update the device capability information managed by the OS 114 on the basis of the collected capability information.

A document generation application 115 is a general application such as a document file generation application, a spreadsheet application, or a presentation application. These applications may be pre-installed in the OS 114, or may be downloaded and installed by the user.

The cloud print server 102 is a server apparatus for providing the cloud print service 121 provided by an OS vendor. In the present embodiment, the cloud print server 102 receives a print instruction and print data from the client terminal 101. The cloud print server 102 then transmits the received print data to the printer 104, thereby providing a service to the user.

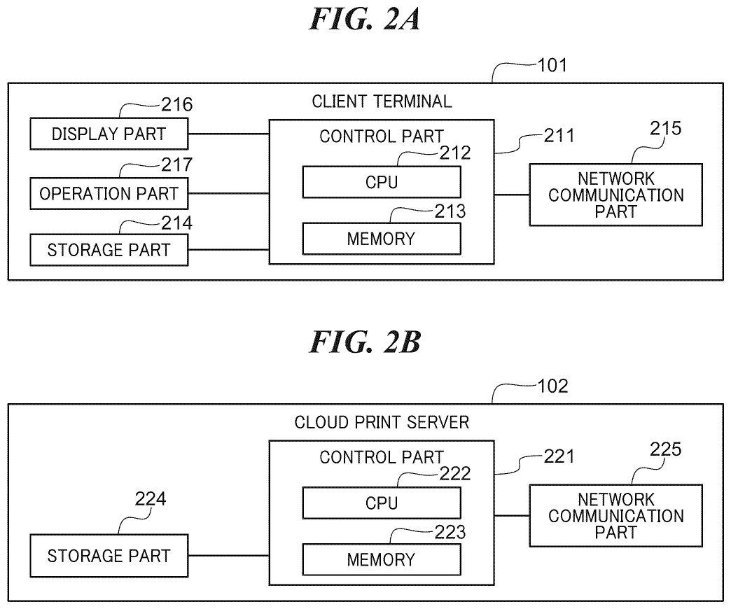

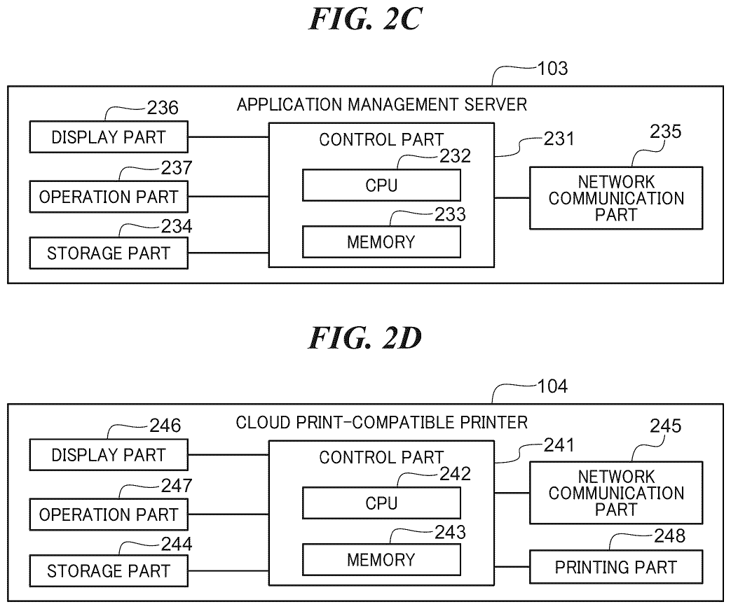

Next, a hardware configuration of each module of the printing system 1 will be described with reference to FIGS. 2A to 2D.

FIG. 2A is a block diagram showing a hardware configuration of the client terminal 101.

The client terminal 101 includes a display part 216, an operation part 217, the storage part 214, the control part 211, and the network communication part 215.

The storage part 214 refers to a nonvolatile storage apparatus such as a hard disk or an SSD, and can store and rewrite digital data.

The control part 211 includes a CPU 212 and a memory 213, and controls the overall operation of the client terminal 101. The CPU 212 loads a computer program stored in the storage part 214 in the memory 213 and executes the program. The memory 213 is a main storage memory of the CPU 212 and is used as a work area and a temporary storage area for loading various programs.

The network communication part 215 is an apparatus that communicates with the external network 107, and inputs/outputs digital data to/from an external server, a client terminal, or the like via the network 107.

The display part 216 is an apparatus such as a liquid crystal display for displaying visual information to the user in real time. The operation part 217 is an apparatus for receiving an input from a user by a keyboard, a mouse, or the like. An apparatus having both functions of the display part 216 and the operation part 217, such as a touch panel, may be used.

FIG. 2B is a block diagram showing a hardware configuration of the cloud print server 102. The cloud print server 102 includes a storage part 224, a control part 221, and a network communication part 225. The control part 211 includes a CPU 222 and a memory 223.

Since the storage part 224, the control part 221, the network communication part 225, the CPU 222, and the memory 223 have functions equivalent to those of the apparatuses having the same names included in the client terminal 101, the description thereof will be omitted.

It should be noted that, in the present embodiment, the cloud print server 102 includes one information processing apparatus having the hardware configuration shown in FIG. 2B, but the cloud print server 102 may include a plurality of information processing apparatuses having the hardware configuration shown in FIG. 2B.

FIG. 2C is a block diagram showing a hardware configuration of an application management server 103. The application management server 103 includes a display part 236, an operation part 237, a storage part 234, a control part 231, and a network communication part 235. The control part 231 includes a CPU 232 and a memory 233.

Since the display part 236, the operation part 237, the storage part 234, the control part 231, the network communication part 235, the CPU 232, and the memory 233 have functions equivalent to those of the apparatuses having the same names included in the client terminal 101, and the description thereof will be omitted.

It should be noted that, in the present embodiment, the application management server 103 includes one information processing apparatus having the hardware configuration shown in FIG. 2C, but the application management server 103 may include a plurality of information processing apparatuses having the hardware configuration shown in FIG. 2C.

FIG. 2D is a block diagram showing a hardware configuration of the printer 104. The printer 104 includes a display part 246, an operation part 247, a storage part 244, a control part 241, a network communication part 245, and a printing part 248. The control part 241 includes a CPU 242 and a memory 243.

The display part 246 is an apparatus for displaying information to the user in real time, such as a touch panel or an LED provided in the printer 104.

The operation part 247 is an apparatus for receiving an input from a user, and may include a hard key such as a numeric keypad in addition to a touch panel. Since the storage part 244, the control part 241, the CPU 242, and the memory 243 have functions equivalent to those of the apparatuses having the same names included in the client terminal 101, the description thereof will be omitted.

The network communication part 245 is an apparatus that communicates with the external network 107, and mainly has a role of receiving print data and transmitting a state of the printer 104, such as an error, to an external server or the like.

The printing part 248 is an apparatus that performs printing processing by performing a series of operations including sheet feeding, printing, and sheet ejection on sheets prepared in a cassette or a tray. A printing method is not particularly limited, and examples thereof include an electrophotographic method and an inkjet method. The printing part 248 also includes a double-sided unit used at the time of sheet ejection and a finishing apparatus such as stapling or punching processing.

It should be noted that, in the present embodiment, a single function printer that performs only a printing function is described as an example of the printer 104, but a multifunction printer (multifunction peripheral) that also has a scanner function and a FAX function may be used.

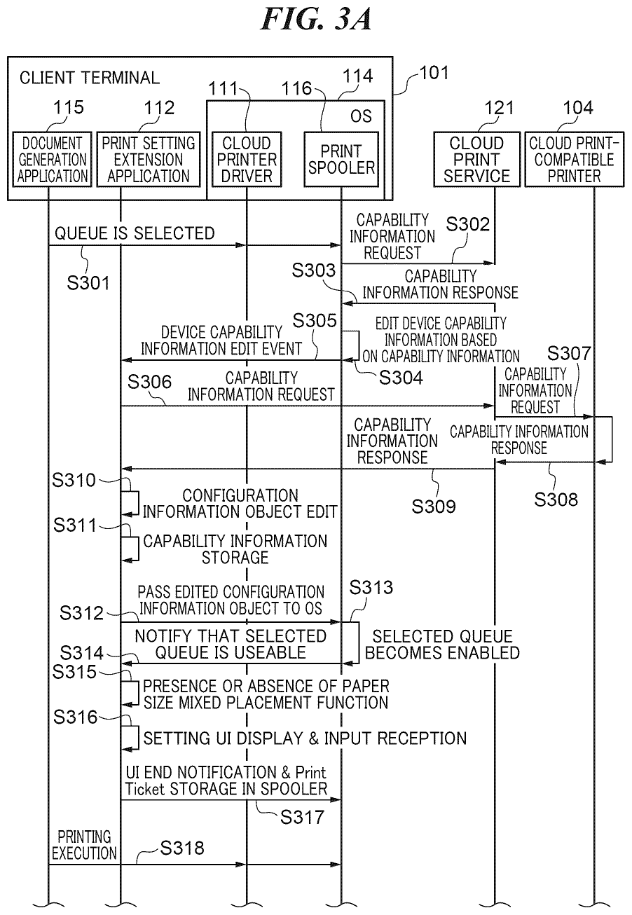

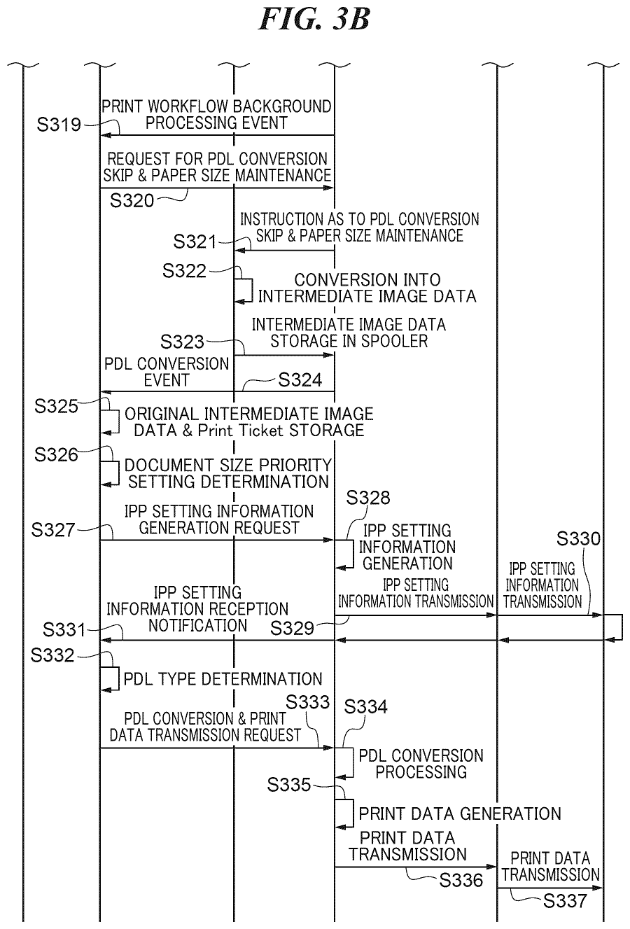

Next, an example of a sequence of processing started by user selection of a print queue in the client terminal 101 in the present embodiment and executed between modules of the printing system 1 will be described with reference to FIG. 3.

It should be noted that FIG. 3 shows processing executed after the information on the printer 104 is registered in the cloud print service 121 and the generation of the print queue is completed. Here, it is assumed that the print queue for transmitting print data generated by the cloud printer driver 111 to the printer 104 via the cloud print service 121 is generated in advance.

The print spooler 116 of the OS 114 accepts the user's selection of the print queue via a print setting UI provided by the document generation application 115 (step S301). Specifically, the user first activates the document generation application 115 in the client terminal 101, opens the document to be printed in the document generation application 115, and instructs printing. In response to this instruction, the document generation application 115 displays an application print setting UI on the display part 216. In the application print setting UI, the printer name of the printer that can print the print data transmitted from the client terminal 101 is displayed in a state selectable by the user. When the user selects the printer name of the printer that prints the document to be printed on the application print setting UI, the print spooler 116 determines that the user has selected the print queue corresponding to the selected printer name. Furthermore, in the application print setting UI, the user can perform print setting for a print target among the limited items that can be set by the local printer driver 113 or the cloud printer driver 111. The limited items of print settings do not include print settings for mixedly placing paper sizes to be described later.

It should be noted that the print queue may be selected on an OS print setting UI provided by the OS 114 different from the application print setting UI provided by the document generation application 115.

In the present embodiment, a description will be given as to a case in which the printer name of the printer 104 as the cloud printer that prints the print data via the cloud print service 121 is selected by the user in step S301 on the application print setting UI.

When the print queue is selected, the print spooler 116 reads a Print Ticket. The Print Ticket is a file indicating print setting information in which current print settings are described in an XML format, and is managed for each print queue. The Print Ticket describes print settings in a format interpretable by the OS 114. The print setting is described by a set of a setting item and a setting value.

Next, the print spooler 116 transmits, to the cloud print service 121, a request for acquiring capability information of the printer (here, the printer 104) corresponding to the print queue selected by the user received in step S301 (step S302). More specifically, the print spooler 116 transmits, to the cloud print service 121, a request for acquiring the capability information on the print setting items supported by the OS 114 among the capability information on the printer 104. For this acquisition request, a command of Get-Printer-Attributes defined by a standard protocol such as Internet Printing Protocol (IPP) is used. At this time, by setting attribute information corresponding to a setting item as an argument of the command, it is possible to acquire the capability information of the setting item designated by the print spooler 116. It should be noted that, in the present embodiment, the attribute name and value are information exchanged according to the IPP.

The cloud print service 121 replies with the capability information of the printer 104 to the print spooler 116 of the OS 114 (step S303). In steps S302 and S303, the capability information is exchanged in the form of an attribute name and value pair defined in the IPP. The attribute name is information indicating a setting item. The attribute value is a value corresponding to a setting value or a value range of each setting item.

The print spooler 116 of the OS 114 edits the capability information acquired from the response from the cloud print service 121 in step S303 as device capability information associated with the print queue of the printer 104 (step S304). The print spooler 116 converts the obtained attribute name and value into a setting item and a setting value that are in a format interpretable by the OS 114, and stores the setting item and the setting value as device capability information. It should be noted that, when the device capability information already associated with the print queue is stored in the print spooler 116, the print spooler 116 adds the capability information acquired in step S303 to the stored device capability information so as to obtain new device capability information.

The print spooler 116 of the OS 114 notifies the device capability collection processing part 112b of the print setting extension application 112 of an event (device capability information editing event) indicating that the device capability information can be edited (step S305).

The device capability collection processing part 112b can use an application programming interface (API) of the OS 114 at a timing when the device capability information editing event is received from the print spooler 116 in step S305. The API is an API for editing the device capability information. At this timing, the print setting extension application 112 can add an attribute name and value corresponding to a setting item and a setting value not supported by the OS 114 but supported by the printer 104 to the device capability information.

Upon receiving the device capability information editing event, the device capability collection processing part 112b acquires, from the cloud print service 121, capability information related to the setting item and the setting value of the printer 104, which are not supported by the OS 114, and edits the device capability information.

Specifically, upon receiving the device capability information editing event from the print spooler 116 in step S305, the device capability collection processing part 112b requests the cloud print service 121 for the capability information of the printer 104 (step S306). It should be noted that, here, the print setting extension application 112 transmits the request to the cloud print service 121, but this request may be made using a function provided by the OS 114.

The print setting extension application 112 stores attribute information corresponding to a setting item for which the capability information is requested. Therefore, in step S306, the device capability collection processing part 112b excludes the attribute information corresponding to the setting item for which the capability information acquisition by the OS 114 has been completed from the attribute information corresponding to the setting item for which the capability information is requested and stored in the print setting extension application 112, and transmits the acquisition request for the capability information. In this way, it is possible to prevent the acquisition request for the capability information from being made redundant for the attribute information for which the acquisition of the capability information has already been completed. It should be noted that the print setting extension application 112 may also acquire the capability information about the attribute information for which the OS 114 has completed the acquisition of the capability information.

Specifically, the device capability collection processing part 112b requests the cloud print service 121 in step S306 for the attribute information selected as a request target according to an IPP standard protocol such as Get-printer-Attributes.

In this manner, the print setting extension application 112 can also acquire capability information for the attribute information not supported by the OS 114. It should be noted that the attribute information not defined in the IPP may be included as a target for which the capability information is requested. In the present embodiment, the attribute information specific to a printer vendor is set as an argument of Get-Printer-Attributes used for the request in step S306. In this manner, it is possible to acquire the capability information even for the attribute information not defined in the IPP.

It should be noted that the processing in step S306 is similar to the processing in step S302 except that the attribute information to be inquired is different. The print setting extension application 112 sets attribute information corresponding to a setting item specific to a printer vendor as an argument of an IPP standard protocol command such as Get-printer-Attributes, and inquires capability information of the setting item specific to a vendor. The setting items specific to a vendor are “paper size mixed”, “needle-less binding”, “saddle folding”, “bookbinding”, and the like.

The cloud print service 121 that has received the request for the capability information in step S306 requests the capability information with respect to the printer 104 by using the IPP (step S307). Specifically, the cloud print service 121 inquires about the capability information of the printer 104 using Get-Printer-Attributes in step S307. At this time, the cloud print service 121 makes an inquiry to the printer 104 using an argument notified from the client terminal 101.

The printer 104 responds with the capability information requested from the cloud print service 121 in step S307 (step S308).

Upon receiving the capability information from the printer 104 in step S308, the cloud print service 121 responds with the capability information requested in step S306 to the print setting extension application 112 based on a received response content (step S309). It should be noted that, in the present embodiment, the cloud print service 121 acquires the capability information from the printer 104 at the timing when the print setting extension application 112 of the client terminal 101 requests the cloud print service 121 to acquire the capability information, but the present invention is not limited thereto. For example, the printer 104 may register in advance all the capability information in the cloud print service 121 regardless of whether the capability information is supported or not supported by the OS 114. In this case, upon receiving the acquisition request for the capability information in step S306, the cloud print service 121 may transmit the capability information registered in advance to the print setting extension application 112.

When acquiring the capability information specific to a vendor from the cloud print service 121 in step S309, the print setting extension application 112 edits the device capability information of the OS 114 via a configuration information object (step S310). That is, by the processing in step S310, the capability information of the setting item specific to a printer vendor, which is not supported by the OS 114, is added to the device capability information of the OS 114.

The configuration information object is a set of data groups necessary for editing the device capability information. Since the print setting extension application 112 cannot directly edit the device capability information included in the OS 114, this configuration information object is edited to change the device capability information included in the OS 114.

At this time, the print setting extension application 112 copies and stores the capability information acquired in steps S306 to S309 and the capability information acquired by the OS 114 in steps S302 and S303 in its own data storage area as device capability information data (step S311).

Next, the print setting extension application 112 passes the configuration information object edited in step S310 to the print spooler 116 of the OS 114 (step S312).

Upon receiving the configuration information object edited from the print setting extension application 112, the print spooler 116 updates the device capability information of the OS 114 based on the device capability information of the OS 114 itself and the received configuration information object (step S313). After updating the device capability information in step S313, the OS 114 enables the print queue selected in step S301. As a result, the print setting UI part 112a of the print setting extension application 112 can be activated.

When the print queue is enabled in step S313, the OS 114 notifies the document generation application 115 that the print queue can be used (step S314). Upon receiving the notification, the document generation application 115 selectively displays a detailed setting button and a print button on the application print setting UI being displayed. In addition, when the document generation application 115 does not have a function of displaying the application print setting UI, a detailed setting button or a print button of a modern print dialog, which is an OS print setting UI displayed by the OS 114, is selectively displayed.

Thereafter, when the user selects the detailed settings button in the application print setting UI being displayed, the print setting UI part 112a is activated. It should be noted that the user operation for starting the print setting UI part 112a may be a user operation other than the selection of the detailed setting button described above.

When the user presses the detailed settings button, the print setting extension application 112 determines the presence or absence of the paper size mixed placement function of the printer 104 based on the capability information stored in step S311 (step S315: determination step). The paper size mixed placement function is a function of performing printing according to each document size when image data to be printed includes different document sizes.

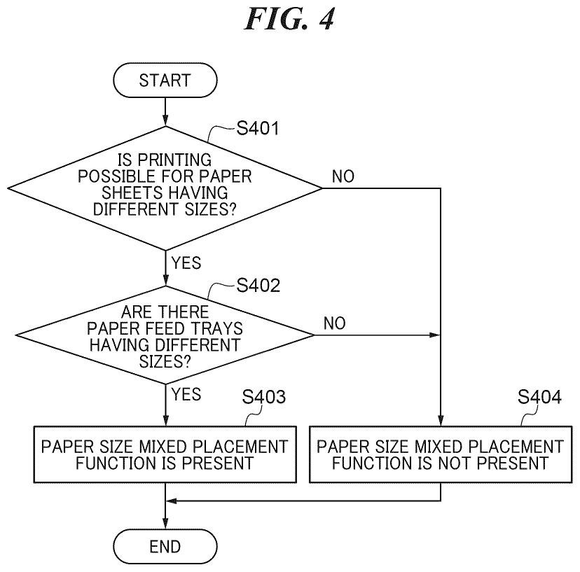

Here, details of determination processing of the presence or absence of the paper size mixed placement function in step S315 will be described with reference to the flowchart of FIG. 4.

The print setting extension application 112 determines whether the printer 104 can perform printing on pieces of paper having different sizes such as A3 and A4 from the capability information stored in step S311 (step S401).

The print setting extension application 112 determines whether the printer 104 includes a plurality of paper feed trays and holds paper sheets having different sizes such as A3 and A4 in each paper feed tray from the capability information stored in step S311 (step S402).

When printing can be performed on paper sheets having different sizes and paper sheets having different sizes are held in the respective paper feed trays (YES in step S401, YES in step S402), the print setting extension application 112 determines that the paper size mixed placement function is present (step S403). In this case, the print setting UI part 112a of the print setting extension application 112 displays a print function setting screen 702 (FIG. 7A) including setting for paper size mixed placement printing as a print setting UI 112d. Thereafter, the present processing (FIG. 4) ends.

The setting for paper size mixed placement printing includes ON/OFF setting of “document size priority”, selection of “paper size mixed placement pattern”, and the like.

On the other hand, when printing cannot be performed on paper sheets having different sizes (NO in step S401), the print setting extension application 112 determines that the paper size mixed placement function is not present (step S404). In addition, when printing can be performed on paper sheets having different sizes, but the paper sheets having different sizes are not held in the respective paper feed trays (YES in step S401, NO in step S402), the print setting extension application 112 determines that the paper size mixed placement function is not present (step S404). In this case, the print setting UI part 112a of the print setting extension application 112 does not display the print function setting screen 702 (FIG. 7A), but displays a print function setting screen 701 (FIG. 7A) that does not include the setting for paper size mixed placement printing. Thereafter, the present processing (FIG. 4) ends.

It should be noted that, in the processing of FIG. 4, two determinations of steps S401 and S402 are made, but only one of the determinations may be made.

Referring back to FIG. 3, the print setting UI part 112a of the print setting extension application 112 receives a user input on the print function setting screen displayed according to the determination result in step S315 (step S316).

Specifically, when it is determined in step S315 that the printer 104 does not have the paper size mixed placement function, the print setting extension application 112 displays the print function setting screen 701 (FIG. 7A). On the print function setting screen 701, the “document size priority” is OFF, and the user cannot change the “document size priority” to ON. On the other hand, the user can select a single sheet size as an output paper size.

On the other hand, when it is determined in step S315 that the printer 104 has the paper size mixed placement function, the print setting extension application 112 displays the print function setting screen 702 (FIG. 7A). On the print function setting screen 702, “document size priority” is ON, and the user can select one of a plurality of patterns (second options) registered in advance as “paper size mixed placement pattern” (pattern setting step). On the other hand, on the print function setting screen 702, the user cannot select the output paper size. On the print function setting screen 702, a user instruction to switch ON (second setting)/OFF (first setting) of “document size priority” using “an ON button 702a and an OFF button 702b” (first option) is received (paper size setting step).

Here, the “paper size mixed placement pattern” is a pattern in which the side of the paper on which finishing processing such as stapling is performed is determined according to the paper size and the printing orientation (portrait or landscape) in a case where the paper sizes are mixed in the documents.

As shown in FIG. 7B, in the present embodiment, the patterns 1 to 4 are set as the “paper size mixed placement pattern”, and a side 704 (position of the margin) on which the finishing processing is performed on the paper sheet, which is set in advance according to the paper size and the printing orientation, is different for each pattern.

However, the “paper size mixed placement pattern” may be fixed to a pattern set by default and may not be selected by the user.

When it is determined in step S315 that the printer 104 has the paper size mixed placement function, the print setting UI part 112a of the print setting extension application 112 may display the print function setting screen shown in FIG. 9 as the print setting UI 112d.

A print function setting screen 901 is a screen indicating a state in which a tab “print setting” is selected.

Here, A4 is set as the paper size.

A print function setting screen 902 is a screen indicating a state in which the tab “exception setting” is selected.

On the print function setting screen 902, the user inputs a page range (here, page 3-6) and a paper size (A3) to which the exception is applied as exception setting. That is, regarding a page to which exception setting is applied on the print function setting screen 902, the user can issue a print instruction with a paper size different from the paper size set on the print function setting screen 901.

The paper size mixed placement pattern on the print function setting screen 902 is the same as the pattern shown in FIG. 7B, and thus description thereof is omitted.

Referring back to FIG. 3, when a setting value is set via the print function setting screen, the print setting UI part 112a writes the setting value in the Print Ticket. Thereafter, when the user closes the print function setting screen and completes the print setting operation, the operation screen of the user returns to the application print setting UI provided by the document generation application 115. Thereafter, the processing proceeds to step S317.

The print setting UI part 112a transmits the Print Ticket and a UI end notification to the print spooler 116 of the OS 114, and completes the processing on the print setting screen of the print setting extension application 112 (step S317). Upon receiving the UI end notification, the print spooler 116 stores the Print Ticket attached to the UI end notification.

Upon receiving a print instruction from the user via the application print setting UI, the document generation application 115 transmits the print execution instruction including image data to be printed to the cloud printer driver 111 of the OS 114 (step S318). Upon receiving a print execution instruction from the document generation application 115, the cloud printer driver 111 notifies the print spooler 116 that the print execution instruction has been received.

Upon receiving a notification indicating that the print execution instruction has been received from the cloud printer driver 111 in step S318, the print spooler 116 notifies the print setting extension application 112 of a print workflow background processing event (step S319). The print workflow background processing event is an event for activating print workflow background processing of the print setting extension application 112. Further, the print workflow background processing is processing of issuing an instruction from the print setting extension application 112 to the cloud printer driver 111 via the print spooler 116 of the OS 114.

The cloud printer driver 111 can generate intermediate image data from data (for example, image data in a GDI format) received from the document generation application 115 in step S318, and further convert the generated data into a page description language (PDL) data. The intermediate image data is data generated before conversion into print data such as PDL, and corresponds to, for example, XPS.

Upon receiving the notification in step S319 from the print spooler 116, the print setting extension application 112 issues an intermediate image data generation request to the print spooler 116 (step S320: intermediate image data generation request step). The intermediate image data generation request includes a request for skipping conversion from the intermediate image data generated by the cloud printer driver 111 to the PDL in response to the request, and a request for maintaining the paper size of the document.

In response to the request issued in step S320, the print spooler 116 issues an instruction to the cloud printer driver 111 so as to generate the intermediate image data, skip the conversion from the intermediate image data to the PDL, and maintain the paper size of the document (step S321).

Upon receiving the two instructions in step S321 from the print spooler 116, the cloud printer driver 111 converts the image data to be printed received from the document generation application 115 in step S318 into the intermediate image data (step S322). However, the cloud printer driver 111 skips the conversion of the intermediate image data into the PDL. At this time, the cloud printer driver 111 maintains the paper size of the document for the paper size of each page in the intermediate image data.

Thereafter, the cloud printer driver 111 transmits the intermediate image data generated in step S322 to the print spooler 116 and stores the intermediate image data in the print spooler 116 (step S323).

Upon receiving the intermediate image data from the cloud printer driver 111 in step S323, the print spooler 116 notifies the print setting extension application 112 of a PDL conversion event (step S324). The PDL conversion event is an event that activates processing of converting the intermediate image data into the PDL that can be processed by the printer 104. At the time of a notification of the event, the print spooler 116 also transmits, to the print setting extension application 112, the Print Ticket in which the intermediate image data and the print setting value set by the application print setting UI or the print setting UI part 112a are recorded.

The print setting extension application 112 sets the intermediate image data received from the print spooler 116 in step S324 as “original intermediate image data”, and stores the same in a data storage area of the print setting extension application 112 together with Print Ticket (step S325).

The print setting extension application 112 determines whether “document size priority” is set to ON in the setting of Print Ticket (step S326).

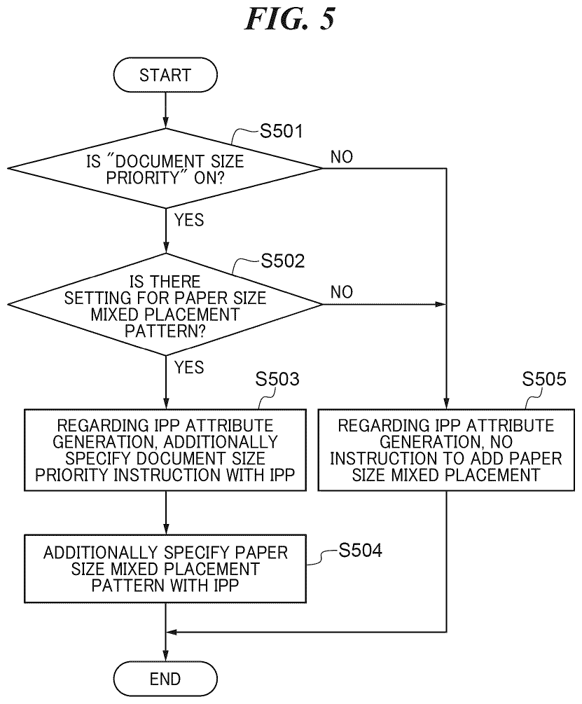

Here, details of the determination processing on presence or absence of the “document size priority” setting in step S326 will be described with reference to the flowchart of FIG. 5.

The print setting extension application 112 determines whether “document size priority” is ON from the setting of Print Ticket (step S501).

When “document size priority” is ON (YES in step S501), the print setting extension application 112 further determines whether the print setting of the paper size mixed placement pattern is present in the Print Ticket (step S502).

When the print setting of the paper size mixed placement pattern is present in the Print Ticket (YES in step S502), the print setting extension application 112 makes a determination to additionally specify document size priority with the IPP regarding generation of an IPP attribute (step S503).

The print setting extension application 112 makes a determination to additionally designate the paper size mixed placement pattern set in the Print Ticket with the IPP (step S504). Thereafter, the present processing (FIG. 5) ends.

When the “document size priority” is OFF (NO in step S501) or when the print setting of the paper size mixed placement pattern is not in the Print Ticket (NO in step S502), the processing proceeds to step S505.

In step S505, the print setting extension application 112 determines that there is no instruction to add the paper size mixed placement regarding the generation of the IPP attribute, and then the present processing (FIG. 5) ends.

Returning to FIG. 3, the print setting extension application 112 uses the API of the OS 114 to perform the generation request of the IPP setting information on the print spooler 116 of the OS 114 (step S327: IPP setting information generation request step). The IPP setting information indicates print setting information defined by a combination of an IPP attribute name and an IPP attribute value. Here, when it is determined in step S326 that the “document size priority” is set, the “mixed placement type” of the paper size is read from the setting of the Print Ticket stored in step S325, and added to the generation request of the IPP setting information.

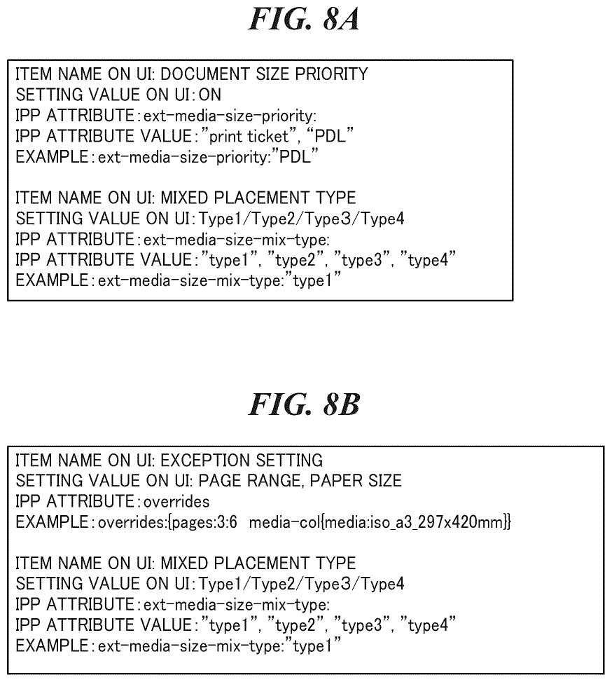

Here, an example of the generation request of the IPP setting information, which is performed by the print setting extension application 112 to the print spooler 116 by using the API of the OS 114 in step S327, will be described with reference to FIGS. 8A and 8B.

FIG. 8A shows an example of a case in which the generation request of the IPP setting information including IPP attributes indicating “document size priority” and “mixed placement type” is transmitted to the print spooler 116 by using the API of the OS 114.

In the example of FIG. 8A, the print setting extension application 112 requests the print spooler 116 to generate an IPP attribute for a document size priority instruction and an IPP attribute for a mixed placement type instruction in accordance with the contents set on the print function setting screen 702 (FIG. 7A).

That is, in the case of FIG. 8A, the IPP attribute for the document size priority instruction is an extended attribute representing “document size priority”, and the IPP attribute for the mixed placement type instruction is an extended attribute representing “mixed placement type”.

FIG. 8B shows an example of a case in which the print setting extension application 112 instructs generation of override of the IPP attribute according to the content of the exception setting set on the print function setting screen 902 (FIG. 9). In this example, the print spooler 116 is requested to generate an override that overwrites the IPP attribute in accordance with the exception setting that pages 3 to 6 are printed with the A3 paper size and the pattern 1 set on the print function setting screen 902.

That is, in the example of FIG. 8B, the IPP attribute for the document size priority instruction is an override attribute indicating the content of the exception setting set on the print function setting screen 902. It should be noted that “override” is an instruction to overwrite a processing instruction such as the IPP attribute embedded in image data to be printed with a processing instruction specified from the outside of the image data.

Referring back to FIG. 3, upon receiving the generation request from the print setting extension application 112 in step S327, the print spooler 116 of the OS 114 generates IPP setting information (step S328). Here, the print spooler 116 generates the IPP setting information according to the received generation request on the basis of the Print Ticket stored in step S317.

The print spooler 116 of the OS 114 transmits the IPP setting information generated in step S328 to the cloud print service 121 (step S329).

The cloud print service 121 transfers the IPP setting information transmitted in step S329 to the printer 104 (step S330).

The printer 104 notifies the print setting extension application 112 of the reception of the IPP setting information via the cloud print service 121 and the print spooler 116 of the OS 114 (step S331).

The print setting extension application 112 determines the PDL type supported by the printer 104 from the capability information of the printer 104 acquired in step S309 (step S332). Here, PWG-Raster or PDF is selected.

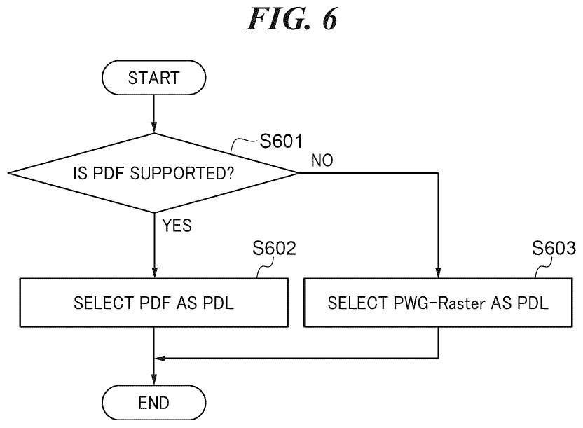

Here, details of the PDL type determination processing supported by the printer 104 in step S332 will be described with reference to the flowchart of FIG. 6.

The print setting extension application 112 determines whether the print function of the printer 104 supports the PDF from the capability information stored in step S311 (step S601).

When the print function of the printer 104 supports the PDF (YES in step S601), the PDF is selected as a PDL to be transmitted to the printer (step S602). Thereafter, the present processing (FIG. 6) ends.

On the other hand, when the print function of the printer 104 does not support the PDF (NO in step S601), the PWG-Raster is selected as the PDL to be transmitted to the printer 104 (step S603). Thereafter, the present processing (FIG. 6) ends.

Returning to FIG. 3, the print setting extension application 112 passes the printing intermediate image data and the PDL type information to the print spooler 116, and requests conversion of the printing intermediate image data into the PDL and transmission of the print data (step S333: print data transmission request step).

The print spooler 116 of the OS 114 converts the printing intermediate image data into the PDL of the designated PDL type by using the printing intermediate image data and the PDL type information from the print setting extension application 112 in step S333 (step S334).

The print spooler 116 of the OS 114 generates print data for transmitting the PDL converted in step S334 to the printer 104 with the IPP (step S335).

The print spooler 116 of the OS 114 transmits the print data generated in step S335 to the cloud print service 121 via the print queue received in step S301 (step S336).

The cloud print service 121 transmits the print data delivered from the print spooler 116 of the OS 114 in step $336 to the printer 104 (step S337). Thereafter, the present processing (FIG. 3) ends.

It should be noted, although the present processing (FIG. 3) exemplifies cloud printing, processing can be performed equally for local printing in which the client terminal 101 and the printer 104 directly communicate with each other without going through the cloud print service 121.

The above description is about a series of flows from displaying the print setting screen by the document generation application 115 to transmitting the print data to the printer 104.

On the application print setting UI displayed by the document generation application 115, a print instruction to the printer is executed via a printer driver that complies with the IPP. Therefore, the user can perform only limited print settings that can be set in the IPP protocol for image data to be printed. However, in the present embodiment, when a user presses a detailed setting button of an application print setting UI, in a case where a printer in a print queue currently selected by the user has a paper size mixed placement function, the print setting extension application 112 displays the print function setting screen 702. On the print function setting screen 702, the user can set the paper size mixed placement printing, which cannot be set by the application print setting UI, for the image data to be printed.

That is, by operating the print function setting screen 702, when the user instructs the printer to print documents including different paper sizes via the printer driver that complies with the IPP, the user can perform print setting according to the paper size.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001154, filed Jan. 9, 2024, which is hereby incorporated by reference wherein in its entirety.

What is claimed is:

1. A non-transitory computer-readable storage medium provided in an information processing apparatus, the non-transitory computer-readable storage medium storing an application program supporting a printer driver that complies with an Internet Printing Protocol (IPP), wherein the application program causes the information processing apparatus to execute:
determining whether image data to be printed includes different document sizes;
determining, upon determining that the image data includes the different document sizes, whether at least one paper sheet for each of the different document sizes included in the image data is set in a printer that performs printing of the image data;
receiving, upon determining that at least one paper sheet for each of the different document sizes included in the image data is set in the printer, selection of a first setting or a second setting from a user, the first setting being configured to perform the printing with a single sheet size selected by the user, the second setting being configured to perform the printing with each of sheets according to each of the different document sizes included in the image data; and
generating, in response to receiving the selection of the second setting, IPP setting information including an IPP attribute corresponding to the second setting for instructing a target printer to perform the printing.

2. The non-transitory computer-readable storage medium according to claim 1, wherein the application program further causes the information processing apparatus to execute:
requesting the printer driver via a print spooler to generate intermediate image data in which the document size of each page of the image data to be printed is maintained; and
requesting the print spooler to convert the intermediate image data into a PDL data, generating print data for transmission of the PDL data compliant with the IPP, and transmitting the print data to the target printer.

3. The non-transitory computer-readable storage medium according to claim 1, wherein the application program further causes the information processing apparatus to execute:
receiving, upon determining that the different document sizes are not included in the image data or upon determining that any one of paper sheet for each of the different document sizes included in the image data is not set in the printer, selection of the single sheet size from the user; and
generating, in response to receiving the selection of the single sheet size, IPP setting information including an IPP attribute corresponding to the single sheet size for instructing the target printer to perform the printing.

4. The non-transitory computer-readable storage medium according to claim 1, wherein the application program further causes the information processing apparatus to execute:
displaying a print function setting screen including an ON button configured to receive, from the user, an instruction to set a document size priority to ON in order to perform the second setting, and an OFF button configured to receive, from the user, an instruction to set the document size priority to OFF in order to perform the first setting.

5. The non-transitory computer-readable storage medium according to claim 4,
wherein the application program further causes the information processing apparatus to execute:
providing, when the ON button is selected by the user, the user with a second option of selecting one of a plurality of paper size mixed placement patterns, and
the IPP setting information includes an IPP attribute for a mixed placement type instruction indicating the paper size mixed placement pattern selected by the user in the second option.

6. The non-transitory computer-readable storage medium according to claim 5, wherein the application program further causes the information processing apparatus to execute:
displaying, when the OFF button is selected by the user, a third option of causing the user to select the single sheet size on the print function setting screen; and
displaying, when the ON button is selected by the user, the second option on the print function setting screen in a state in which the third option is set to be non-selectable by the user.

7. The non-transitory computer-readable storage medium according to claim 5, wherein the paper size mixed placement patterns are determined according to a document size and a printing orientation.

8. The non-transitory computer-readable storage medium according to claim 5, wherein the application program further causes the information processing apparatus to execute:
determining, when the ON button is selected by the user, that paper size mixed placement printing is to be performed.

9. The non-transitory computer-readable storage medium according to claim 8, wherein the application program further causes the information processing apparatus to execute:
determining, when none of the paper size mixed placement patterns is selected by the user in the second option, that the paper size mixed placement printing is not to be performed.

10. The non-transitory computer-readable storage medium according to claim 4, wherein the IPP attribute corresponding to the second setting is an extended attribute indicating ON/OFF setting of the document size priority.

11. The non-transitory computer-readable storage medium according to claim 5, wherein the IPP attribute for the mixed placement type instruction is an extended attribute indicating the paper size mixed placement pattern selected by the user in the second option.

12. The non-transitory computer-readable storage medium according to claim 1, wherein the application program further causes the information processing apparatus to execute:
displaying, in response to receiving the selection of the second setting, a print function setting screen that receives, from the user, an input of a page to be an exception setting and an input of a paper size of the page among the image data to be printed.

13. The non-transitory computer-readable storage medium according to claim 12, wherein an IPP attribute for a document size priority instruction overrides embedded instructions, and a content of the exception setting takes precedence over the embedded instructions.

14. An information processing apparatus comprising:
an application program that supports a printer driver, and the printer driver complies with Internet Printing Protocol (IPP),
wherein the application program is configured to:
determine whether image data to be printed includes different document sizes;
determine, upon determining that the image data includes the different document sizes, whether at least one paper sheet for each of the different document sizes included in the image data is set in a printer that performs printing of the image data;
receive, upon determining that at least one paper sheet for each of the different document sizes included in the image data is set in the printer, selection of a first setting or a second setting from a user, the first setting being configured to perform the printing with a single sheet size selected by the user, the second setting being configured to perform the printing with each of sheets according to each of the different document sizes included in the image data; and
generate, in response to receiving the selection of the second setting, IPP setting information including an IPP attribute corresponding to the second setting for instructing a target printer to perform the printing.

15. A control method for controlling an information processing apparatus on which an application program is operable, the application program supports a printer driver, and the printer driver complies with an Internet Printing Protocol (IPP), the control method comprising:
determining whether image data to be printed includes different document sizes;
determining, upon determining that the image data includes the different document sizes, whether at least one paper sheet for each of the different document sizes included in the image data is set in a printer that performs printing of the image data;
receiving, upon determining that at least one paper sheet for each of the different document sizes included in the image data is set in the printer, selection of a first setting or a second setting from a user, the first setting being configured to perform the printing with a single sheet size selected by the user, the second setting being configured to perform the printing with each of sheets according to each of the different document sizes included in the image data; and
generating, in response to receiving the selection of the second setting, IPP setting information including an IPP attribute corresponding to the second setting for instructing a target printer to perform the printing.
